(19) United States
(12) Patent Application Publication
(10) Pub. No.: US 2019/0134783 A1
(43) Pub. Date: May 9, 2019

(54) SUPERHARD CONSTRUCTIONS & METHODS OF MAKING SAME

(71) Applicant: Element Six (UK) Limited, Oxfordshire (GB)

(72) Inventor: Dong WANG, Oxfordshire (GB)

(21) Appl. No.: 16/232,245

(22) Filed: Dec. 26, 2018

Related U.S. Application Data
(63) Continuation of application No. 15/540,747, filed on Jun. 29, 2017, now abandoned.

(51) Int. Cl. B24D 18/00; B22F 7/06; B22F 9/02; C22C 26/00; E21B 10/567; C04B 35/626; B22F 1/00; C04B 35/645; C04B 37/02; C04B 35/528; B22F 5/00

(52) U.S. Cl. CPC B24D 18/0009; C04B 2237/363; B22F 9/026; C22C 26/00; E21B 10/567; C04B 35/62655; C04B 35/6264; B22F 1/0014; C04B 35/645; C04B 37/021; C04B 35/528; B22F 2998/10; C22C 2026/005; C22C 2026/006; C04B 2237/401; C22C 2026/008; B22F 2005/001; C04B 2235/3847; C04B 2235/386; C04B 2235/40; C04B 2235/427; C04B 2235/5436; C04B 2235/5445; C04B 2235/5472; C04B 2235/96; C22C 2026/007; B22F 7/06

(57) ABSTRACT

A method of forming a super hard polycrystalline construction comprises forming a liquid suspension of a first mass of nano-ceramic particles and a mass of particles or grains of super hard material having an average particle or grain size of 1 or more microns, dispersing the particles or grains in the liquid suspension to form a substantially homogeneous suspension, drying the suspension to form an admix of the nano-ceramic and super hard grains or particles, and forming a pre-sinter assembly comprising the admix. The pre-sinter assembly is then sintered to form a body of polycrystalline super hard material comprising a first fraction of super hard grains and a second fraction, the nano-ceramic particles forming the second fraction. The super hard grains are spaced along at least a portion of the peripheral surface by one or more nano-ceramic grains, the super hard grains having a greater average grain size than that of the grains in the second fraction which have an average size of less than around 999 nm.

### FIELD

This disclosure relates to super hard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth.

### BACKGROUND

Polycrystalline super hard materials, such as polycrystalline diamond (PCD) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), or a thermally stable product TSP material such as thermally stable polycrystalline diamond.

Polycrystalline diamond (PCD) is an example of a super hard material (also called a super abrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify. To form the cutting element with a super hard material layer such as PCD, diamond particles or grains are placed adjacent the cemented tungsten carbide body in a refractory metal enclosure such as a niobium enclosure and are subjected to high pressure and high temperature so that inter-grain bonding between the diamond grains occurs, forming a polycrystalline super hard diamond layer.

In some instances, the substrate may be fully cured prior to attachment to the super hard material layer whereas in other cases, the substrate may be green, that is, not fully cured. In the latter case, the substrate may fully cure during the HTHP sintering process. The substrate may be in powder form and may solidify during the sintering process used to sinter the super hard material layer.

Ever increasing drives for improved productivity in the earth boring field place ever increasing demands on the materials used for cutting rock. Specifically, super hard materials, such as PCD materials, with improved abrasion and impact resistance are required to achieve faster cut rates and longer tool life.

Cutting elements or tool inserts comprising PCD material are widely used in drill bits for boring into the earth in the oil and gas drilling industry. Rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite.

The most wear resistant grades of PCD usually suffer from a catastrophic fracture of the cutter before it has worn out. During the use of these cutters, cracks grow until they reach a critical length as which catastrophic failure occurs, namely, when a large portion of the PCD breaks away in a brittle manner. These long, fast growing cracks encountered during use of conventionally sintered PCD, result in short tool life.

Furthermore, despite their high strength, polycrystalline diamond (PCD) materials are usually susceptible to impact fracture due to their low fracture toughness. Improving fracture toughness without adversely affecting the material's high strength and abrasion resistance is a challenging task.

There is therefore a need for a super hard composite such as a PCD composite that has good or improved abrasion, fracture and impact resistance and a method of forming such composites.

### SUMMARY

Viewed from a first aspect there is provided a method of forming a super hard polycrystalline construction, comprising:

forming a liquid suspension of a first mass of nano-ceramic particles and a mass of particles or grains of super hard material having an average particle or grain size of 1 or more microns;

dispersing the nano-ceramic particles and mass of super hard particles or grains in the liquid suspension to form a substantially homogeneous suspension;

drying the suspension to form an admix of the nano-ceramic particles and super hard grains or particles;

forming a pre-sinter assembly comprising the admix;

treating the pre-sinter assembly in the presence of a catalyst/solvent material for the super hard grains at an ultra-high pressure of around 5 GPa or greater and a temperature to sinter together the grains of super hard material to form a body of polycrystalline super hard material comprising a first fraction of super hard grains and a second fraction, the super hard grains exhibiting inter-granular bonding and defining a plurality of interstitial regions therebetween;

the nano-ceramic particles forming the second fraction; wherein

the super hard grains in the first fraction are spaced along at least a portion of the peripheral surface by one or more nano-ceramic grains in the second fraction;

the super hard grains in the first fraction having a greater average grain size than the average grain size of the grains in the second fraction, the average size of the grains in the second fraction being less than around 999 nm and the average grain size of the grains of superhard material in the first fraction being around 1 micron or more.

Viewed from a second aspect there is provided a super hard polycrystalline construction comprising:

a body of polycrystalline super hard material comprising a first fraction of super hard grains and a second fraction of nano-ceramic material;

the super hard grains in the first fraction having a peripheral surface; wherein

the super hard grains in the first fraction are spaced along at least a portion of their peripheral surface by a plurality of nano-ceramic grains or clusters of nano-ceramic grains; wherein the average grain size of the super hard grains in the first fraction is around 1 micron or more.

### BRIEF DESCRIPTION OF THE DRAWINGS

Various versions will now be described by way of example and with reference to the accompanying drawings in which:

FIG. 1 is a perspective view of an example PCD cutter element or construction for a drill bit for boring into the earth;

FIG. 2 is a schematic cross-section of a portion of a conventional PCD micro-structure with interstices between the inter-bonded diamond grains filled with a non-diamond phase material;

FIG. 3 is a schematic cross-section of a portion of an example PCD micro-structure;

FIG. 4 is a plot showing the results of a vertical borer test comparing a conventional PCD cutter element and an example cutter element;

FIG. 5 is a plot showing the results of a vertical borer test comparing a conventional PCD cutter element and two example cutter elements which contained residual catalyst binder in the interstitial spaces (unleached); and

FIG. 6 is a plot showing the results of a vertical borer test comparing a conventional PCD cutter element and an example cutter element from which residual catalyst binder in the interstitial spaces had been removed (leached).

The same references refer to the same general features in all the drawings.

### DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto or alternatively the body of polycrystalline material may be free-standing and unbacked.

As used herein, polycrystalline diamond (PCD) is a type of polycrystalline super hard (PCS) material comprising a mass of diamond grains, a substantial portion of which are directly inter-bonded with each other and in which the content of diamond is at least about 80 volume percent of the material. As used herein, “interstices” or “interstitial regions” are regions between the diamond grains of PCD material. In some examples of PCD material, interstices between the diamond grains may be at least partly filled with a binder material comprising a catalyst for diamond. In some examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” regions or parts are produced contiguous with each other and are not separated by a different kind of material.

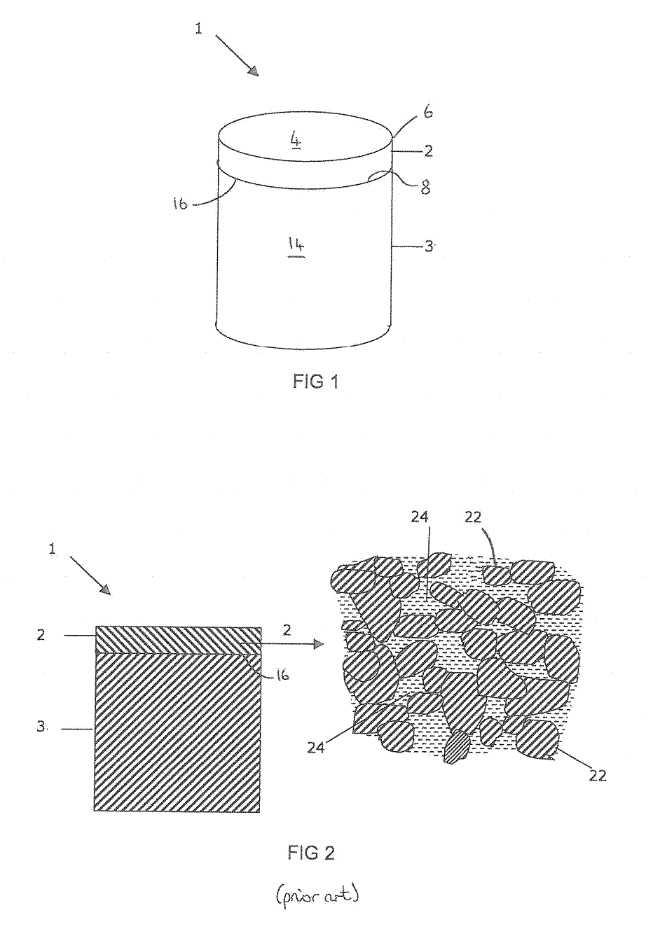

An example of a super hard construction is shown in FIG. 1 and includes a cutting element 1 having a layer of super hard material 2 formed on a substrate 3. The substrate 3 may be formed of a hard material such as cemented tungsten carbide. The super hard material 2 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, also known as the working surface, which is the surface which, along with its edge 6, performs the cutting in use.

At one end of the substrate 3 is an interface surface 8 that forms an interface with the super hard material layer 2 which is attached thereto at this interface surface. As shown in the example of FIG. 1, the substrate 3 is generally cylindrical and has a peripheral surface 14 and a peripheral top edge 16.

The super hard material may be, for example, polycrystalline diamond (PCD) and the super hard particles or grains may be of natural or synthetic origin.

The substrate 3 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 3 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 2 during formation of the compact 1.

As shown in FIG. 2, during formation of a conventional polycrystalline composite construction, the diamond grains are directly inter-bonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron. The typical average grain size of the diamond grains 22 is larger than 1 micron and the grain boundaries between adjacent grains is therefore typically between micron-sized diamond grains, as shown in FIG. 2.

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

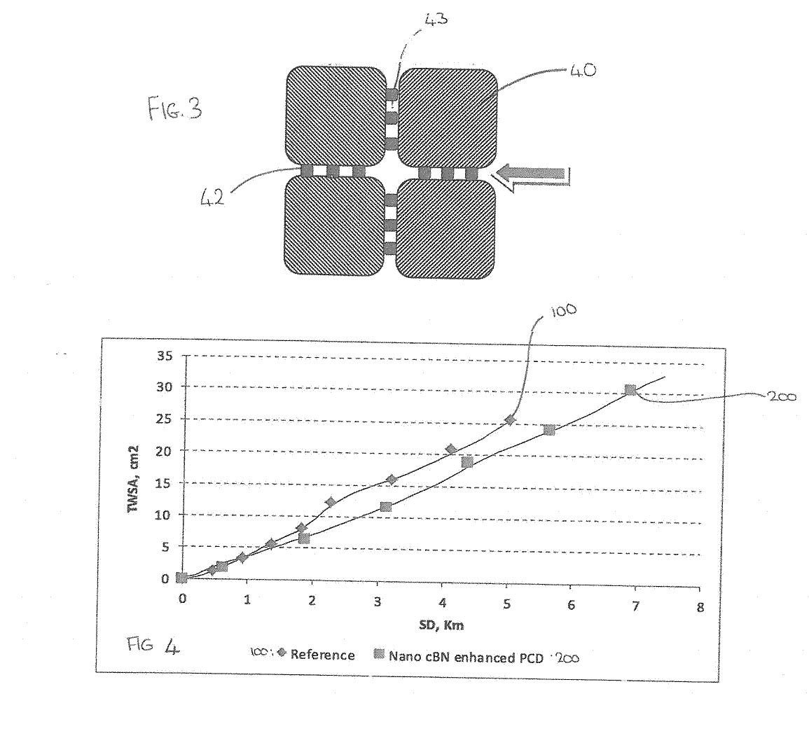

FIG. 3 is a cross-section through an example of polycrystalline super hard material forming the super hard layer 2 of FIG. 1 showing, schematically, the microstructure. The polycrystalline material comprises a first phase dispersed in the super hard phase 40 and comprising super hard grains 40 spaced by a second phase comprising nano-sized particles or clusters of particles 42 formed of a ceramic material that, in some examples, may not chemically react with the super hard grains, and/or not inter-grow. Residual catalyst/binder phase 43 may be disposed between the first and second phases 40, 42. The second phase 42 may comprise, for example, any one or more of an oxide material, a carbide material, alumina, zirconia, yttria, silica, tantalum oxide, cBN, PCBN, boron nitride, tungsten carbide, hafnium carbide, zirconium carbide, silicon carbide, silicon nitride or any combination thereof. The grain size of the dispersed second phase particles 42 may, in some examples, be less than around 999 nm, and in some examples 100 nm or less, and/or in the examples comprising clusters of ceramic particles, the average size of the clusters of nano-sized particles may be, for example around 5 microns or less and in some examples, around 500 nm or less.

In some examples, these dispersed second phase particles 42 may be localized inside the binder pools or in between the grains of the super hard particles, depending on the respective sizes.

The grains of super hard material may be, for example, diamond grains or particles. In the starting mixture prior to sintering they may be, for example, bimodal, that is, the feed comprises a mixture of a coarse fraction of diamond grains and a fine fraction of diamond grains. In some examples, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction. For example, the fine fraction may have an average grain size of between around 1/10 to 6/10 of the size of the coarse fraction, and may, in some examples, range for example between about 0.1 to 20 microns.

In some examples, the weight ratio of the coarse diamond fraction to the fine diamond fraction may range from about 50% to about 97% coarse diamond and the weight ratio of the fine diamond fraction may be from about 3% to about 50%. In other examples, the weight ratio of the coarse fraction to the fine fraction may range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some examples the different size components of the compact are separated by an order of magnitude between the separate size fractions making up the multimodal distribution.

Some examples consist of a wide bi-modal size distribution between the coarse and fine fractions of super hard material, but some examples may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In examples where the super hard material is polycrystalline diamond material, the diamond grains used to form the polycrystalline diamond material may be natural and/or synthetic.

In some examples, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

The cutter of FIG. 1 according to a first version having the microstructure of FIG. 3 may be fabricated, for example, as follows.

A mass of hard nano-ceramic particle materials, such as nano cBN, nano tungsten carbide, nano boron carbide, nano silicon carbide, nano silicon nitride having, for example, an average grain size of less than around 100 nm, is thoroughly dispersed in a liquid, such as (deionized) water or an organic solvent, for example ethanol, with or without surfactants using a sonication process by inserting an ultrasonic probe into the liquid to form a suspension. Alternatively or in addition, a cluster of such hard nano-ceramic particles may be pre-formed using a conventional nano precipitation technique and dispersed in such a liquid to form a suspension. The clusters may have, for example, an average size of around 5 microns or less, or in some examples around 500 nm or less. Micron sized diamond grits having an average grain size of greater than 1 micron are added to the mixture and a sintering agent such as cobalt may also be added. The mixture is then subjected to a further sonication process by applying the ultrasonic probe into the mixture for a further period of time to form a homogeneous mixture. The resulting mixture is then dried using a fast drying process to maintain the homogeneity. An example of a suitable technique for drying the suspension is freeze drying using, for example, liquid nitrogen, or spray drying, or spray granulation to form a substantially homogeneously mixed admix powder in which the nano-ceramic particles or clusters are coated on/attached to micron-sized diamond grits. The admix powder is then sintered under conventional diamond sintering conditions, for example at a pressure of around 6.8 GPa, and temperature of around 1300 degrees C., in some examples with a preformed WC substrate to form a PCD structure such as that shown in FIG. 3 in which the nano-ceramic particles or clusters 42 are located between grain boundaries of the larger diamond grains 40.

Various techniques may be used to achieve this dispersion and homogenous mixture such as ultrasonic dispersing, ball milling, homogenization, and jet milling techniques.

Also, a fast drying process to dry the nano-ceramic/diamond suspension without agglomeration may assist in achieving the desired microstructure in the sintered product. Suitable drying techniques to assist in inhibiting agglomeration of the materials during drying may include freeze drying, spray freeze drying, spray drying, and spray granulation or spray freeze granulation.

In the example in which a spray drying technique is used, a suitable inlet temperature may be, for example, around 120 deg C., and a suitable outlet temperature of around 50-56 deg C., and a feeding rate of around 5.8 ml/min may be used.

In the example in which a freeze drying technique is used, the admix may be in the form of a homogeneous paste which is frozen using liquid nitrogen, and is then placed into a freeze dryer for several days until the paste is thoroughly dried. The freeze drying conditions may be optimized for different solvents, for example, for deionized water, the preferred operation temperature is −55 deg C. plus/minus 5 deg C., and the preferred pressure is between around 50 to 500 microbar.

In some examples, the catalyst binder such as cobalt may instead be added to the dried admix powder rather than be included in the liquid suspension.

In some examples, a stabilizer such as a polymeric stabiliser for example a surfactant may be added to the suspension mixture. The surfactant may be, for example, a non-ionic or cationic surfactant. Also, a binding material such as polyvinyl alcohol may be added to the suspension mixture to assist in inhibiting agglomeration.

The micron-sized diamond particles or grains may be subjected to a heat treatment or acid treatment prior to adding these to the suspension mixture to clean the particles or grains by removing impurities. A suitable heat treatment temperature for micron-sized diamond grits may be, for example, between around 1000 to around 1300 deg C., or between around 1100 to around 1300 deg C., or between around 1200 to around 1300 deg C.

In some examples, the admix material comprising the nano-ceramics and micron-sized diamond admix, and the carbide material for forming the substrate plus any additional sintering aid/binder/catalyst may be applied as powders and sintered simultaneously in a single UHP/HT process. The admix of nano-ceramic and micron sized diamond grains, and mass of carbide powder material are placed in an HP/HT reaction cell assembly and subjected to HP/HT processing. The HP/HT processing conditions selected are sufficient to effect intercrystalline bonding between the diamond grains as well as, optionally, the joining of sintered particles to the cemented metal carbide support. In one example, the processing conditions generally involve the imposition for about 3 to 120 minutes of a temperature of at least about 1200 degrees C. and an ultra-high pressure of greater than about 5 GPa.

In another example, the substrate may be pre-sintered in a separate process before being bonded to the polycrystalline material in the HP/HT press during sintering of the ultrahard polycrystalline material.

In a further example, both the substrate and a body of polycrystalline super hard material are pre-formed. The preformed body of polycrystalline super hard material is placed in the appropriate position on the upper surface of the preformed carbide substrate (incorporating a binder catalyst), and the assembly is located in a suitably shaped canister. The assembly is then subjected to high temperature and pressure in a press, the order of temperature and pressure being again, at least around 1200 degrees C. and 5 GPa respectively. During this process the solvent/catalyst migrates from the substrate into the body of super hard material and acts as a binder-catalyst to effect intergrowth in the layer and also serves to bond the layer of polycrystalline super hard material to the substrate.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate. The binder material may comprise between about 10 to 50 wt. % Ni, between about 0.1 to 10 wt. % Cr, and the remainder weight percent comprises Co.

The PCD construction 1 described with reference to FIGS. 1 and 3, may be further processed after sintering. For example, catalyst material may be removed from a region of the PCD structure adjacent the working surface or the side surface or both the working surface and the side surface. This may be achieved by treating the PCD structure with acid to leach out catalyst material from between the diamond grains, or by other methods such as electrochemical methods. A thermally stable region, which may be substantially porous, extending a depth of at least about 50 microns or at least about 100 microns from a surface of the PCD structure, may thus be formed which may further enhance the thermal stability of the PCD element.

Furthermore, the PCD body in the structure of FIG. 1 comprising a PCD structure bonded to a cemented carbide support body may be treated or finished by, for example, grinding, to provide a PCD element which is substantially cylindrical and having a substantially planar working surface, or a generally domed, pointed, rounded conical or frusto-conical working surface. The PCD element may be suitable for use in, for example, a rotary shear (or drag) bit for boring into the earth, for a percussion drill bit or for a pick for mining or asphalt degradation.

In addition, after sintering, the polycrystalline super hard constructions may be ground to size and may include, if desired, a chamfer, for example of around 45 degrees and of approximately 0.4 mm height measured parallel to the longitudinal axis of the construction.

Some versions are discussed in more detail below with reference to the following examples, which are not intended to be limiting.

### Example 1

3 g of nano cBN having an average particle size of less than around 100 nm was suspended in 15 ml of ethanol and the suspension was treated with sonication probe for at least 15 minutes to thoroughly disperse the nano cBN. In a separate beaker, 1 g of B90 was dissolved into 20 ml ethanol, and then mixed with the nano cBN dispersion. The mixture was concentrated to 20 ml by evaporating the excess amount of ethanol in a Rotavap. Following the concentration, 5 ml of deionized water was introduced into the ethanol concentration and the nano cBN together with B90 was precipitated out of the ethanol solution to form nano clusters of nano cBN.

In a separate beaker, 67.9 g of diamond grains having an average grain size of around 22 microns (Grade 22) was suspended in 30 ml deionized water and the nano clusters of nano cBN solution were then introduced into the suspension. The mixture was gently stirred with an overhead stirrer for at least half an hour to obtain nano clusters of nano cBN coated diamond.

In a separate beaker, 2 g of SP cobalt and 1 g of surfactant was mixed with 20 ml of deionized water, and subjected to a sonication process with ultrasonic probe for 15 minutes. 29.1 g of diamond grains having an average grain size of around 2 microns (Grade 2) was introduced into the suspension and the suspension was subjected to a sonication process for a further 5 minutes. This suspension was then introduced into the suspension comprising the diamond grains having an average grain size of 22 microns (grade 22) and the resulting mixture was gently stirred with an overhead stirrer for 10 minutes to form a final admix suspension. The final admix suspension was spray dried with a BUCHI Mini-290 spray dryer to remove liquids and form an admix powder. The spray dryer conditions were:

Atomization Pressure: 3 Bar

Inlet temperature: 120° C.

Outlet temperature: 50˜56° C.

Feeding rate: 5.8 ml/min

2.1 g of the admix powder was then placed into a canister with a pre-formed cemented WC substrate to form a pre-sinter assembly, which was then loaded into a press and subjected to an ultra-high pressure and a temperature at which the super hard material is thermodynamically stable to sinter the super hard grains. The pressure to which the assembly was subjected was about 6.8 GPa and the temperature was at least about 1,200 degrees centigrade. The sintered PCD construction was then removed from the canister.

A conventional PCD cutter construction formed of the same mixture of diamond grain sizes (grades) as set out in the above example, but without adding the nano-ceramic material was prepared in a conventional manner for forming PCD by mixing using conventional milling and mixing techniques and the mixture was sintered with a pre-formed cemented carbide substrate under the same conditions as above for the example containing the nano-ceramic additions.

The prepared PCD constructions formed according to the above methods were compared in a vertical boring mill test. The results are shown in FIG. 4.

The first PCD construction tested was that formed of the conventional diamond grain mixture (without any nano-ceramic additions) and the results are shown in FIG. 4 by line 100. The second PCD construction tested was a first example formed with the nano-cBN additions described above and the results are shown in FIG. 4 by line 200.

In this test, the wear flat area was measured as a function of the number of passes of the construction boring into the workpiece and the results obtained are illustrated graphically in FIG. 4.

The results provide an indication of the total wear scar area plotted against cutting length. It will be seen that the PCD construction formed according to the example (line 200) was able to achieve a significantly greater cutting length than that occurring in the conventional PCD compact (shown by line 100 in FIG. 4) which was subjected to the same test for comparison and the PCD construction formed according to the example (line 200) was able to achieve a smaller wear scar area than that occurring in the conventional PCD compact (shown by line 100 in FIG. 4).

Thus it will be seen from FIG. 4 that the PCD construction formed with the inclusion of nano-ceramic material in the admix in the manner described above from a homogeneously distributed solution to enable the nano-ceramic to coat the larger diamond grains as shown in FIG. 3 prior to sintering showed an improvement in cutting distance and abrasion resistance over the conventional PCD construction (line 100).

### Example 2

3 g of nano WC having an average particle size of less than around 100 nm was suspended in 15 ml of ethanol and the suspension was treated with sonication probe for at least 15 minutes to thoroughly disperse the nano WC. In a separate beaker, 1 g of B90 was dissolved into 20 ml ethanol, and then mixed with the nano WC dispersion. The mixture was concentrated to 20 ml by evaporating the excess amount of ethanol in a Rotavap. Following the concentration, 5 ml of deionized water was introduced into the ethanol concentration and the nano WC together with B90 was precipitated out of the ethanol solution to form nano clusters of nano WC having an average cluster size of around 1200 nm.

In a separate beaker, 67.9 g of diamond grains having an average grain size of around 22 microns (Grade 22) was suspended in 30 ml deionized water and the nano clusters of nano WC solution were then introduced into the suspension. The mixture was gently stirred with an overhead stirrer for at least half an hour to obtain nano clusters of nano WC coated diamond.

In a separate beaker, 2 g of SP cobalt and 1 g of surfactant was mixed with 20 ml of deionized water, and subjected to a sonication process with ultrasonic probe for 15 minutes. 29.1 g of diamond grains having an average grain size of around 2 microns (Grade 2) was introduced into the suspension and the suspension was subjected to a sonication process for a further 5 minutes. This suspension was then introduced into the suspension comprising the diamond grains having an average grain size of 22 microns (grade 22) and the resulting mixture was gently stirred with an overhead stirrer for 10 minutes to form a final admix suspension. The final admix suspension was spray dried with a BUCHI Mini-290 spray dryer to remove liquids and form an admix powder. The spray dryer conditions were:

Atomization Pressure: 3 Bar

Inlet temperature: 120° C.

Outlet temperature: 50˜56° C.

Feeding rate: 5.8 ml/min

2.1 g of the admix powder comprising around 3 wt % WC nano-clusters was then placed into a canister with a pre-formed cemented WC substrate to form a pre-sinter assembly, which was then loaded into a press and subjected to an ultra-high pressure and a temperature at which the super hard material is thermodynamically stable to sinter the super hard grains. The pressure to which the assembly was subjected was about 6.8 GPa and the temperature was at least about 1,200 degrees centigrade. The sintered PCD construction was then removed from the canister.

A conventional PCD cutter construction formed of the same mixture of diamond grain sizes (grades) as set out in the above example, but without adding the nano-ceramic material was prepared in a conventional manner for forming PCD by mixing using conventional milling and mixing techniques and the mixture was sintered with a pre-formed cemented carbide substrate under the same conditions as above for the example containing the nano-ceramic additions.

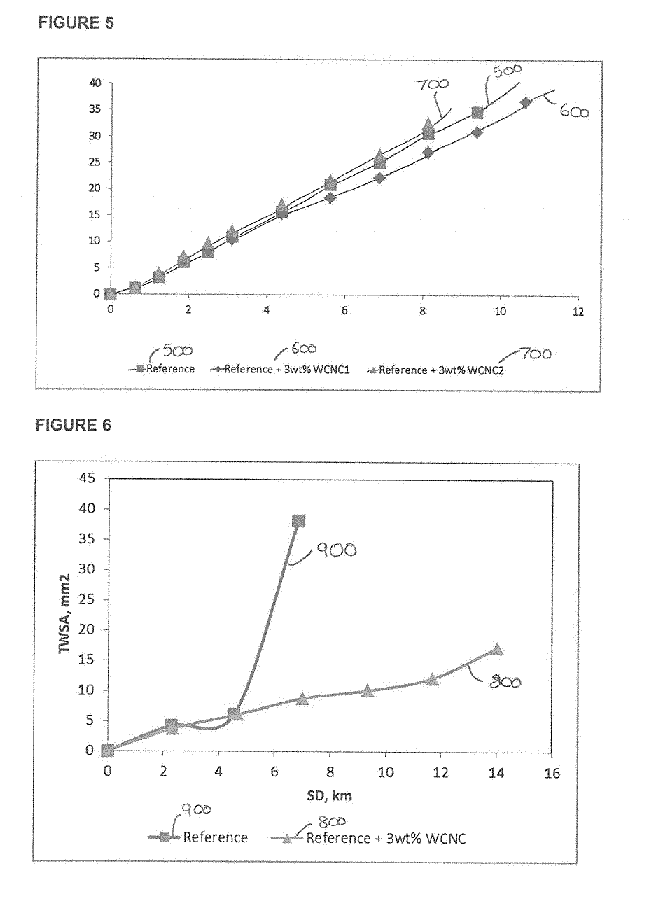

The prepared PCD constructions formed according to the above methods were compared in a vertical boring mill test. The results are shown in FIG. 5.

The first PCD construction tested was that formed of the conventional diamond grain mixture (without any nano-ceramic additions) and the results are shown in FIG. 5 by line 500. The second PCD construction tested was a first example formed with the nano-WC additions described above and the results are shown in FIG. 5 by line 600. A third PCD construction was also tested which was a further example formed with the nano-WC additions described above to test repeatability and the results are shown in FIG. 5 by line 700. All samples tested in the test whose results are shown in FIG. 5 were in the unleached state, that is, the samples had not been subjected to a post synthesis treatment to remove residual binder catalyst from the interstices.

As shown in FIG. 5, the two example constructions (600, 700) showed no reduction on abrasive resistance compared to the conventional PCD construction in the unleached state.

An additional sample according to example 2 was produced as was an additional reference cutter which was formed of the same mixture of diamond grain sizes (grades) as set out in the above example 2, but without adding the nano-ceramic material, and it was prepared in a conventional manner for forming PCD by mixing using conventional milling and mixing techniques and the mixture was sintered with a pre-formed cemented carbide substrate under the same conditions as above for the example containing the nano-ceramic additions. The constructions were then subjected to an acid leaching treatment to remove residual catalyst binder from the interstices. The treated PCD constructions were then compared in a further vertical boring mill test. The results are shown in FIG. 6.

In this test, the wear flat area was measured as a function of the number of passes of the construction boring into the workpiece and the results obtained are illustrated graphically in FIG. 6.

The results provide an indication of the total wear scar area plotted against cutting length. It will be seen that the PCD construction formed according to the example (line 800) was able to achieve a significantly greater cutting length than that occurring in the conventional PCD compact (shown by line 900 in FIG. 6) which was subjected to the same test for comparison and the PCD construction formed according to the example (line 800) was able to achieve a smaller wear scar area than that occurring in the conventional PCD compact (shown by line 900 in FIG. 6).

Thus it will be seen from FIG. 6 that the leached PCD construction formed with the inclusion of nano-ceramic material in the admix in the manner described above from a homogeneously distributed solution to enable the nano-ceramic to coat the larger diamond grains as shown in FIG. 3 prior to sintering showed an improvement in cutting distance and abrasion resistance over the conventional PCD construction (line 900).

Whilst not wishing to be bound by a particular theory, it is believed that the fracture performance of PCD may be improved through the introduction of a nano-sized second phase comprising hard ceramic materials which may not chemically react with the super hard grains, and/or may not inter-grow. The second phase, particularly those formed of a cluster of nano particles, are believed to promote crack bifurcation or multiple crack fronts in the PCD material in use, resulting in a redistribution of available strain energy or energy release rate (G) amongst the various crack tips, and/or favourably divert cracks in the PCD material. A material that is able to generate multiple cracks under loading would behave tougher than a material with only one major crack since multiple crack fronts ensures that the net energy supplied to the material is divided between several cracks, resulting in a much slower rate of crack growth through the material. The end result in application of the PCD material including such micro-defects is that, in use, the number of cracks initiated on the wear scar may be increased as compared to conventional PCD, thus reducing the strain energy available for each individual crack, hence slowing the growth rate, and the generation of shorter cracks. The ideal case is where the wear rate is comparable to the crack growth rate, in which case no cracks will be visible behind the wear scar thereby forming a smooth wear scar appearance with no chips or grains pulled out of the sintered PCD.

The addition of such a second phase may also have the effect of increasing the thermal stability of the PCD through the resultant lower cobalt content in the material of the examples compared to conventional PCD.

The size, shape and distribution of these second phase particles, grains, clusters, granules or agglomerates may be tailored to the final application of the PCD material. It is believed possible to improve fracture resistance without significantly compromising the overall abrasion resistance of the material, which is desirable for PCD cutting tools.

Thus, it is believed that one or more examples may provide a means of toughening PCD material without compromising its high abrasion resistance and may assist in enabling the creation of multiple crack-fronts or defects which may help to redistribute or dissipate the available fracture energy. These defects may also promote crack bifurcations, which is another energy dissipation mechanism. The end result is that there may be insufficient energy available to each individual crack to enable it to propagate quickly and hence this may significantly slow down the rate of crack growth.

The vertical borer test results of these engineered structures show a considerable increase in PCD cutting tool life compared to conventional PCD, and with no degradation in abrasion resistance.

Observation of the wear scar development during testing showed the example material's ability to generate large wear scars without exhibiting brittle-type micro-fractures (e.g. spalling or chipping), leading to a longer tool life.

Thus, examples of a PCD material may be formed having that a combination of high abrasion and fracture performance.

The microstructure of the PCD constructions formed according to one or more of the above described example methods may be determined using conventional image analysis techniques such as scanning electron micrographs (SEM) taken using a backscattered electron signal.

The homogeneity or uniformity of the PCD structure may be quantified by conducting a statistical evaluation using a large number of micrographs of polished sections. The distribution of the filler phase, which is easily distinguishable from that of the diamond phase using electron microscopy, can then be measured in a method similar to that disclosed in EP 0 974 566 (see also WO2007/110770). This method allows a statistical evaluation of the average thicknesses of the binder phase along several arbitrarily drawn lines through the microstructure. This binder thickness measurement is also referred to as the “mean free path” by those skilled in the art.

While various versions have been described with reference to a number of examples, those skilled in the art will understand that various changes may be made and equivalents may be substituted for elements thereof and that these examples are not intended to limit the particular examples or versions disclosed.

For example, in some embodiments of the method, the PCD material may be sintered for a period in the range from about 1 minute to about 30 minutes, in the range from about 2 minutes to about 15 minutes, or in the range from about 2 minutes to about 10 minutes.

In some examples of the method, the sintering temperature may be in the range from about 1,200 degrees centigrade to about 2,300 degrees centigrade, in the range from about 1,400 degrees centigrade to about 2,000 degrees centigrade, in the range from about 1,450 degrees centigrade to about 1,700 degrees centigrade, or in the range from about 1,450 degrees centigrade to about 1,650 degrees centigrade.

In one example, the method may include removing residual metallic catalyst/binder material for diamond from interstices between the diamond grains of the PCD material. In some examples, the PCD structure may have a region adjacent a surface comprising at most about 2 volume percent of catalyst material for diamond. In further examples, the PCD structure may additionally have a region remote from the surface comprising greater than about 2 volume percent of catalyst material for diamond. In some such examples, the region adjacent the surface may extend to a depth of at least about 20 microns, at least about 80 microns, at least about 100 microns or even at least about 400 microns from the surface, or greater.

1. A method of forming a super hard polycrystalline construction, comprising:
forming a liquid suspension of a first mass of nano-ceramic particles and a mass of particles or grains of super hard material having an average particle or grain size of 1 or more microns;
dispersing the nano-ceramic particles and mass of super hard particles or grains in the liquid suspension to form a substantially homogeneous suspension;
drying the suspension to form an admix of the nano-ceramic particles and super hard grains or particles;
forming a pre-sinter assembly comprising the admix;
treating the pre-sinter assembly in the presence of a catalyst/solvent material for the super hard grains at an ultra-high pressure of around 5 GPa or greater and a temperature to sinter together the grains of super hard material to form a body of polycrystalline super hard material comprising a first fraction of super hard grains and a second fraction, the super hard grains exhibiting inter-granular bonding and defining a plurality of interstitial regions therebetween;
the nano-ceramic particles forming the second fraction; wherein
the super hard grains in the first fraction are spaced along at least a portion of the peripheral surface by one or more nano-ceramic grains in the second fraction;
the super hard grains in the first fraction having a greater average grain size than the average grain size of the grains in the second fraction, the average size of the grains in the second fraction being less than around 999 nm and the average grain size of the grains of superhard material in the first fraction being around 1 micron or more.

2. The method of claim 1, wherein the step of forming a liquid suspension comprises forming a liquid suspension comprises forming the suspension of the first mass of nano-ceramic particles and super hard grains or particles, wherein the nano-ceramic particles are in the form of one or more clusters of nano-ceramic particles.

3. The method of claim 1, wherein the step of providing a mass of super hard material comprises providing a mass of natural and/or synthetic diamond grains, the super hard polycrystalline construction forming a polycrystalline diamond (PCD) construction.

4. The method of claim 1, further comprising treating the super hard construction to remove at least a portion of residual binder/catalyst from at least a portion of interstitial spaces between interbonded super hard grains.

5. The method of claim 1, wherein the step of forming a liquid suspension of a first mass of nano ceramic and a mass of particles or grains of super hard material comprises dispersing the nano-ceramic and super hard particles or grains in deionized water.

6. The method of claim 1, wherein the step of dispersing the nano-ceramic and mass of super hard particles or grains in the liquid suspension to form a substantially homogeneous suspension comprises applying to the liquid suspension one or more of:
a sonication process;
an ultrasonic dispersion process;
a homogenization process; and/or
a jet milling process.

7. The method of claim 1, wherein the step of drying the suspension to form an admix of the nano-ceramic and super hard grains or particles comprises one or more of drying the suspension using freeze drying spray freeze drying, spray drying, spray granulation, and/or spray freeze granulation.

8. The method of claim 1, wherein the average grain size of the nano-ceramic grains or particles in the admix is around 999 nm or less, or around 500 nm or less, or around 250 nm or less, or around 100 nm or less.

9. The method of claim 1, wherein the second fraction comprises one or more clusters of nano ceramic particles, the average size of the clusters being less around 5 microns or less, or around 500 nm or less.

10. The method of claim 1, wherein the nano-ceramic material comprises one or more of an oxide material, a carbide material, alumina, zirconia, yttria, silica, tantalum oxide, cBN, PCBN, boron nitride, tungsten carbide, hafnium carbide, zirconium carbide, silicon carbide, silicon nitride or any combination thereof.

11. A super hard polycrystalline construction comprising:
a body of polycrystalline super hard material comprising a first fraction of super hard grains and a second fraction of nano-ceramic material;
the super hard grains in the first fraction having a peripheral surface; wherein
the super hard grains in the first fraction are spaced along at least a portion of their peripheral surface by a plurality of nano-ceramic grains or clusters of nano-ceramic grains; wherein the average grain size of the super hard grains in the first fraction is around 1 micron or more.

12. The super hard polycrystalline construction of claim 12, wherein the grains in the first fraction comprise natural and/or synthetic diamond grains, the super hard polycrystalline construction forming a polycrystalline diamond (PCD) construction.

13. The super hard polycrystalline construction of claim 14, wherein the PCD construction further comprises a non-super hard phase comprising a binder phase located in interstitial spaces between the inter-bonded diamond grains.

14. The super hard polycrystalline construction according to claim 15, wherein the binder phase comprises cobalt, and/or one or more other iron group elements, such as iron or nickel, or an alloy thereof, and/or one or more carbides, nitrides, borides, and oxides of the metals of Groups IV-VI in the periodic table.

15. The super hard polycrystalline construction according to claim 12, wherein at least a portion of the body of super hard material is substantially free of a catalyst material for diamond, said portion forming a thermally stable region.

16. The super hard polycrystalline construction as claimed in claim 20, wherein the thermally stable region comprises at most 2 weight percent of catalyst material for diamond.

17. The super hard polycrystalline construction of claim 12, wherein the first fraction comprises a mass of super hard abrasive grains having two or more different average grain sizes.

18. The super hard polycrystalline construction of claim 12, wherein the nano-ceramic grains in the second fraction are arranged to space one or more adjacent grains in the first fraction by a distance of less than around 999 nm, or less than around 500 nm, or less than around 250 nm, or less than around 100 nm.

19. The super hard polycrystalline construction of claim 12, wherein the second fraction comprises clusters of nano-ceramic grains, the clusters having an average size of less than around 5 microns, or less than around 1 micron, or less than around 500 nm.

20. The super hard polycrystalline construction of claim 12, wherein the nano-ceramic material comprises one or more of an oxide material, a carbide material, alumina, zirconia, yttria, silica, tantalum oxide, cBN, PCBN, boron nitride, tungsten carbide, hafnium carbide, zirconium carbide, silicon carbide, silicon nitride or any combination thereof.
